(19) United States
(12) Patent Application Publication
(10) Pub. No.: US 2026/0001585 A1
(43) Pub. Date: Jan. 1, 2026

(54) DRIVE UNIT

(71) Applicant: EXEDY Corporation, Osaka (JP)

(72) Inventor: Naoya TAKAHASHI, Osaka (JP)

(21) Appl. No.: 19/220,310

(22) Filed: May 28, 2025

(30) Foreign Application Priority Data
Jun. 27, 2024 (JP) 2024-103574

(51) Int. Cl. B62B 5/04; B62B 3/06; B62B 5/00; F16D 63/00; F16H 7/06

(52) U.S. Cl. CPC B62B 5/0461; B62B 5/0033; B62B 5/0066; F16D 63/006; F16H 7/06; B62B 3/06

(57) ABSTRACT

A drive unit includes a frame, a drive wheel, an electric motor, a rotary member, and a brake mechanism. The drive wheel is rotatably supported by the frame. The electric motor is supported by the frame. The electric motor is configured to drive the drive wheel. The rotary member is configured to be rotated in conjunction with the drive wheel. The brake mechanism includes an engaging portion. The brake mechanism is switchable between a braking state and an unbraking state. The braking mechanism is set in the braking state such that the engaging portion is engaged with the rotary member so as to brake rotation of the rotary member. The braking mechanism is set in the unbraking state such that the engaging portion is disengaged from the rotary member so as to make the rotary member rotatable. Thus, a mobile object is prevented from unintentionally moving after stopping.

### CROSS-REFERENCE TO RELATED APPLICATIONS

This application is based on and claims the priority benefit of application No. 2024-103574 filed on Jun. 27, 2024, the contents of which are incorporated herein by reference.

### TECHNICAL FIELD

The present invention relates to a drive unit.

### BACKGROUND

It has been proposed to enhance the performance of a mobile object moved at a low speed such as a pallet truck, a hand lift truck, a hand truck, or a wheelchair by attaching a drive unit thereto (Japanese translation of PCT International Application Publication No. 2014-512307). The drive unit includes a drive wheel, an electric motor, and so forth. When the mobile object is caused to travel by a human drive force, the electric motor outputs an assist force for assisting the human drive force.

### SUMMARY OF THE INVENTION

When the drive unit configured as described above is attached to a mobile object, it is a concern that the mobile object may unintentionally move when it should be stopped and motionless. In view of this, it is an object of the present invention to provide a drive unit, by which a mobile object can be prevented from unintentionally moving when it should be stopped.

A drive unit according to a first aspect includes a frame, a drive wheel, an electric motor, a rotary member, and a brake mechanism. The drive wheel is rotatably supported by the frame. The electric motor is supported by the frame. The electric motor is configured to drive the drive wheel. The rotary member is configured to be rotated in conjunction with the drive wheel. The brake mechanism includes an engaging portion. The brake mechanism is switchable between a braking state and an unbraking state. The brake mechanism is set in the braking state such that the engaging portion is engaged with the rotary member so as to brake rotation of the rotary member. The brake mechanism is set in the unbraking state such that the engaging portion is disengaged from the rotary member so as to make or to allow the rotary member to be rotatable.

According to this configuration, the engaging portion of the brake mechanism is engaged with the rotary member, whereby rotation of the rotary member can be braked. As a result, a mobile object can be prevented from unintentionally moving when it has been stopped.

A drive unit according to a second aspect relates to the drive unit according to the first aspect and is configured as follows. The engaging portion is movable along an axial direction of the rotary member.

A drive unit according to a third aspect relates to the drive unit according to the first or second aspect and is configured as follows. The rotary member is a sprocket. The engaging portion is engaged with teeth of the sprocket when the brake mechanism is set in the braking state.

A drive unit according to a fourth aspect relates to the drive unit according to the third aspect and is configured as follows. The engaging portion is partially disposed outside tips of the teeth of the sprocket in a radial direction of the sprocket.

A drive unit according to a fifth aspect relates to the drive unit according to the third or fourth aspect and is configured as follows. The engaging portion is in contact with the teeth of the sprocket at a position outside a pitch circle of the sprocket in a radial direction of the sprocket.

A drive unit according to a sixth aspect relates to the drive unit according to any of the first to fifth aspects and further includes a transmission member. The transmission member is configured to transmit mechanical power between the electric motor and the drive wheel. The rotary member is attached to an output shaft of the electric motor. The electric motor and the engaging portion are movable in an extending direction of the transmission member.

A drive unit according to a seventh aspect relates to the drive unit according to any of the first to sixth aspects and is configured as follows. The brake mechanism includes an attachment plate and a brake body. The attachment plate is attached to the frame. The brake body is attached to the attachment plate. The brake body includes the engaging portion on a distal end thereof.

A drive unit according to an eighth aspect relates to the drive unit according to the seventh aspect and is configured as follows. The electric motor is attached to the frame so as to be pivotable about a pivot axis. The attachment plate is attached to the frame so as to be pivotable about the pivot axis.

A drive unit according to a ninth aspect relates to the drive unit according to any of the first to eighth aspects and further includes a drive wheel sprocket. The drive wheel sprocket is attached to a rotational shaft of the drive wheel. The rotary member is an electric motor sprocket attached to an output shaft of the electric motor.

A drive unit according to a tenth aspect relates to the drive unit according to the ninth aspect and is configured as follows. The engaging portion is engaged with teeth of the electric motor sprocket at a position on or above an imaginary line connecting a rotational axis of the electric motor sprocket and a rotational axis of the drive wheel sprocket.

Overall, according to the present invention, a mobile object can be prevented from unintentionally moving after being stopped.

### BRIEF DESCRIPTION OF THE DRAWINGS

FIG. 1 is a side view of a drive unit attached to a pallet truck.

FIG. 2 is a side view of the drive unit.

FIG. 3 is a side view of the drive unit, from which one of a pair of side plates and so forth are detached.

FIG. 4 is a cross-sectional view of the drive unit taken along line IV-IV in FIG. 2.

FIG. 5 is a diagram corresponding to FIG. 4 in an unbraking state of a brake mechanism of the drive unit.

FIG. 6 is a diagram showing an engaged state of an engaging portion with an electric motor sprocket of the drive unit.

### DETAILED DESCRIPTION

A preferred embodiment of a drive unit 100 attached to a pallet truck 200 will be hereinafter explained with reference to drawings. The drive unit 100 is configured to assist the traveling of a mobile object. The drive unit 100 is attached to the mobile object. It should be noted that the mobile object is caused to travel by a human drive force. The mobile object is moved at a low speed. The mobile object is configured to transport an object. It should be noted that the term “object” is conceptualized as encompassing a person or so forth as well. A pallet truck, a hand lift truck, a hand truck, a wheelchair, or so forth is exemplified as the mobile object described above. It should be noted that the pallet truck 200 is exemplified as the mobile object in the present preferred embodiment. In the following explanation, the term “forward” and its related terms mean a moving direction of the pallet truck 200 pulled by a user, i.e., a direction in which an operating handle 202 and the drive unit 100 lead, whereas the term “rearward” and its related terms mean a moving direction of the pallet truck 200 pushed by the user, i.e., a direction opposite “forward.”

### <Pallet Truck>

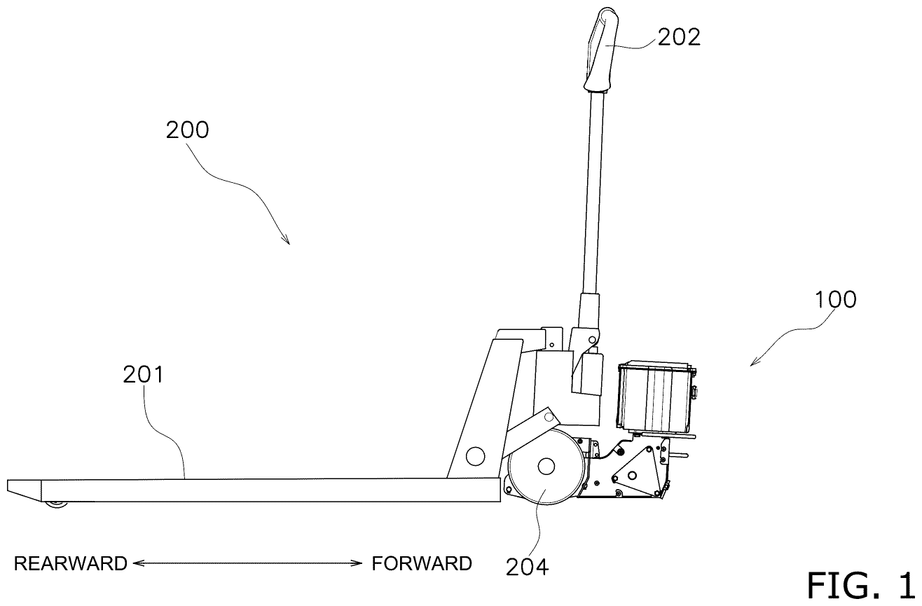

FIG. 1 is a side view of the pallet truck 200 to which the drive unit 100 is attached. It should be noted that the right side in FIG. 1 corresponds to the front side, whereas the left side in FIG. 1 corresponds to the rear side. As shown in FIG. 1, the pallet truck 200 includes a loading platform (a pair of fork arms) 201, the operating handle 202, and a plurality of vehicle wheels 204. It should be noted that each vehicle wheel 204 is a non-drive wheel. The drive unit 100 is attached to the pallet truck 200.

### <Drive Unit>

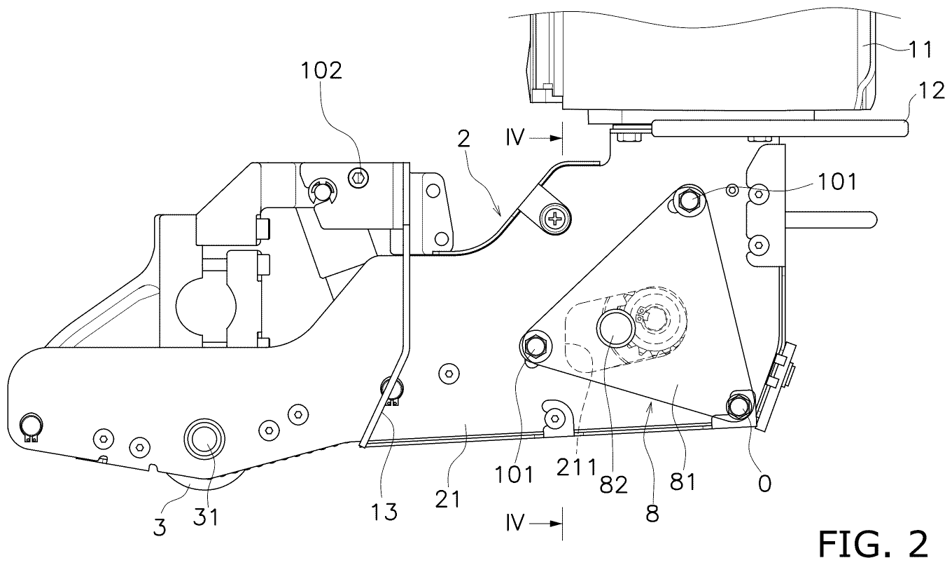

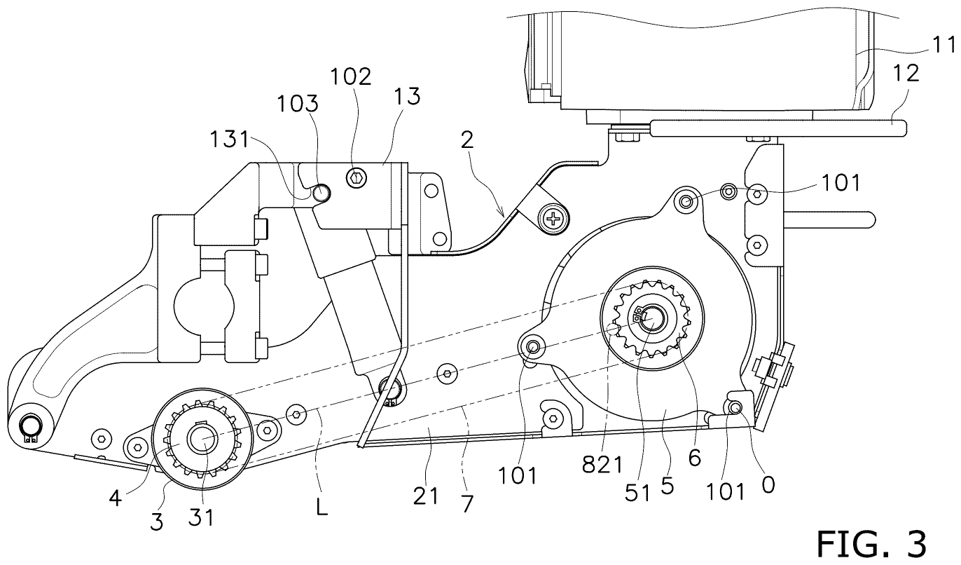

FIG. 2 is a side view of the drive unit 100, whereas FIG. 3 is a side view of the drive unit 100, from which one of a pair of side plates 21 and so forth are detached. As shown in FIGS. 2 and 3, the drive unit 100 includes a frame 2, a drive wheel 3, a drive wheel sprocket 4, an electric motor 5, an electric motor sprocket 6 (exemplary rotary member), a chain 7 (exemplary transmission member), and a brake mechanism 8. Besides, the drive unit 100 further includes a battery 11, a mount plate 12, and a pair of vehicle wheel covers 13.

### <Frame>

The frame 2 is configured to support respective members. The frame 2 includes the pair of side plates 21. The side plates 21 are disposed away from each other at an interval in a width direction. The side plates 21 are fastened to each other by a plurality of bolts and so forth.

### <Drive Wheel and Drive Wheel Sprocket>

The drive wheel 3 is rotatably supported by the frame 2. When described in detail, a rotational shaft 31 of the drive wheel 3 is rotatably supported by the frame 2 through a bearing member and so forth. The rotational shaft 31 of the drive wheel 3 extends in the width direction. The rotational shaft 31 is rotated unitarily with the drive wheel 3.

The lower end of the drive wheel 3 is disposed below that of the frame 2. In other words, the drive wheel 3 is in contact with a floor surface. Preferably, the frame 2 is not in contact with the floor surface. The drive wheel 3 rolls on the floor surface. It should be noted that the drive unit 100 includes the single drive wheel 3 in the present preferred embodiment; alternatively, the drive unit 100 may include a plurality of drive wheels 3.

The drive wheel sprocket 4 is attached to the rotational shaft 31 of the drive wheel 3. The drive wheel sprocket 4 is configured to be rotated unitarily with the drive wheel 3.

### <Electric Motor, Electric Motor Sprocket, and Chain>

When the pallet truck 200 is caused to travel by a human drive force of the user, the electric motor 5 outputs an assist force for assisting with the traveling of the pallet truck 200. It should be noted that the electric motor 5 may output a torque for causing the pallet truck 200 to travel, while an operating portion of the operating handle 202 is being operated by the user. The electric motor 5 is configured to drive and to rotate the drive wheel 3.

The electric motor 5 includes an output shaft 51. The output shaft 51 is rotated unitarily with a rotor of the electric motor 5. The output shaft 51 extends in the width direction. It should be noted that the extending direction of the output shaft 51 is also referred to as an axial direction. In other words, the width direction is synonymous with the axial direction.

The electric motor sprocket 6 is attached to the output shaft 51 of the electric motor 5. The electric motor sprocket 6 is configured to be rotated unitarily with the output shaft 51. The electric motor sprocket 6 is disposed ahead of or on the forward side of the drive wheel sprocket 4. In addition, the electric motor sprocket 6 is disposed above the drive wheel sprocket 4.

The chain 7 is configured to transmit mechanical power between the electric motor sprocket 6 and the drive wheel sprocket 4. In other words, the chain 7 is stretched over the electric motor sprocket 6 and the drive wheel sprocket 4.

The electric motor sprocket 6 rotates unitarily with the drive wheel sprocket 4 through the chain 7; further, the drive wheel sprocket 4 rotates unitarily with the drive wheel 3. In other words, the electric motor sprocket 6 is configured to be rotated in conjunction with the drive wheel 3.

The electric motor 5 is supported by the frame 2. The electric motor 5 is disposed ahead of or on the forward side of the drive wheel 3. The electric motor 5 is movable in the extending direction of the chain 7. In other words, the electric motor 5 can be moved in both directions along the extending direction of the chain 7 such that the electric motor sprocket 6 is moved closer to and away from the drive wheel sprocket 4.

When described in detail, the electric motor 5 is attached to the frame 2 so as to be pivotable about a pivot axis O. When described in more detail, the electric motor 5 is attached to a plurality of bolts 101 each extending in the width direction so as to fasten the pair of side plates 21. It should be noted that one of the bolts 101 serves as the pivot axis O. The remaining bolts 101 fasten the pair of side plates 21 through a plurality of pairs of elongated holes provided in the pair of side plates 21, respectively. Because of this, the electric motor 5 is made pivotable about the pivot axis O.

When the electric motor 5 is rotated clockwise about the pivot axis O in FIG. 3, the electric motor sprocket 6 is moved away from the drive wheel sprocket 4. As a result, the chain 7 can be stretched tight when slacking. It should be noted that FIGS. 2 and 3 show a condition made after the electric motor 5 is rotated clockwise.

### <Brake Mechanism>

The brake mechanism 8 is configured to brake the rotation of the drive wheel 3 in the drive unit 100. The brake mechanism 8 is switchable between a braking state and an unbraking state. In the braking state, the brake mechanism 8 brakes the rotation of the electric motor sprocket 6. It should be noted that the electric motor sprocket 6 is rotated in conjunction with the drive wheel 3; hence, when the rotation of the electric motor sprocket 6 is braked, that of the drive wheel 3 is braked as well.

Alternatively, in the unbraking state, the brake mechanism 8 allows the electric motor sprocket 6 to be rotatable. In other words, in the unbraking state, the brake mechanism 8 releases the braking of the rotation of the electric motor sprocket 6.

The brake mechanism 8 includes an attachment plate 81 and a brake body 82. The attachment plate 81 is attached to the frame 2. When described in detail, the attachment plate 81 is fastened to the pair of side plates 21 by the bolts 101 to which the electric motor 5 is attached. Because of this, the attachment plate 81 is attached to the frame 2 so as to be pivotable about the pivot axis O. It should be noted that the attachment plate 81 is disposed to cover an opening 211 provided in one of the pair of side plates 21.

The brake body 82 is attached to the attachment plate 81. Because of this, the brake body 82 is pivotable about the pivot axis O together with the attachment plate 81. In other words, the brake body 82 is movable in the extending direction of the chain 7 in a manner comparable to that of the electric motor 5. When described in detail, the brake body 82 pivots unitarily with the electric motor 5. The brake body 82 extends to penetrate one of the pair of side plates 21 through the opening 211 provided therein.

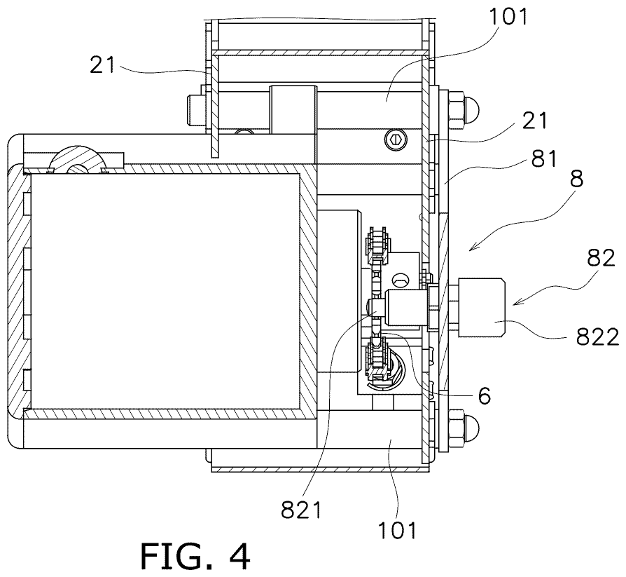

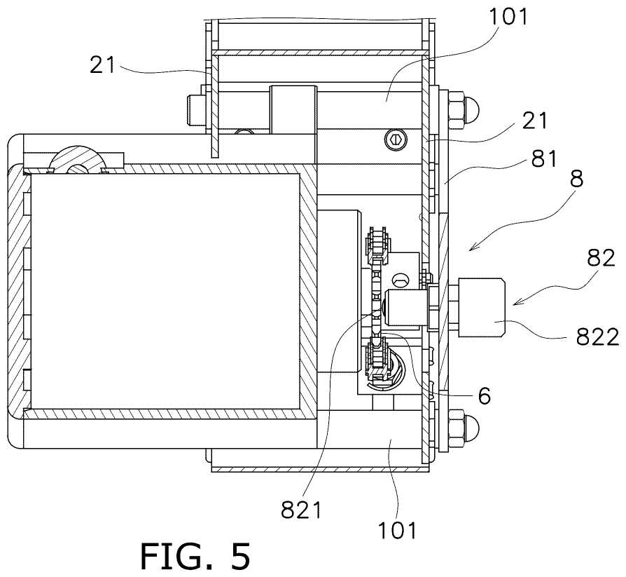

FIG. 4 is a cross-sectional view of the drive unit 100 taken along line IV-IV in FIG. 2. FIG. 5 is a diagram corresponding to FIG. 4 in an unbraking state of a brake mechanism. It should be noted that in FIG. 4, the brake mechanism 8 is set in the braking state. As shown in FIGS. 4 and 5, the brake body 82 includes an engaging pin 821 (exemplary engaging portion) on the distal end thereof. The engaging pin 821 axially protrudes or retracts by operating an operating portion 822 of the brake body 82. In other words, the engaging pin 821 is movable along the axial direction of the electric motor sprocket 6.

The engaging pin 821 axially protrudes or retracts by rotating the operating portion 822. For example, the brake body 82 is made in the form of an index plunger. When axially protruded, the engaging pin 821 is engaged with the teeth of the electric motor sprocket 6. Alternatively, when axially retracted, the engaging pin 821 disengages with the teeth of the electric motor sprocket 6. It should be noted that FIG. 4 shows the protruded state of the engaging pin 821. When retracted, the engaging pin 821 is moved to the right side in FIG. 4 and is thereby disengaged from the teeth of the electric motor sprocket 6.

When the brake mechanism 8 is set in the braking state, the engaging pin 821 engages with the teeth of the electric motor sprocket 6. Specifically, when the brake mechanism 8 is set in the braking state, the engaging pin 821 protrudes toward the electric motor sprocket 6 and thereby engages with the teeth of the electric motor sprocket 6. Alternatively, when the brake mechanism 8 is set in the unbraking state, the engaging pin 821 disengages from the teeth of the electric motor sprocket 6. Specifically, when the brake mechanism 8 is set in the unbraking state, the engaging pin 821 retracts away from the electric motor sprocket 6 and is thereby disengaged from the teeth of the electric motor sprocket 6.

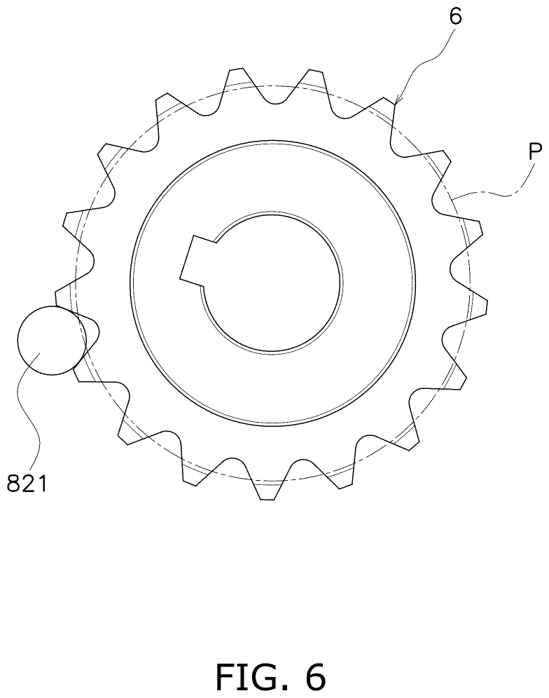

FIG. 6 is a diagram showing the engaged state of the engaging pin 821 with the electric motor sprocket 6. As shown in FIG. 6, when the brake mechanism 8 is set in the braking state, the engaging pin 821 is engaged with the teeth of the electric motor sprocket 6. In other words, the engaging pin 821 is disposed between any one of the pairs of adjacent teeth.

The engaging pin 821 is disposed partially outside the tips of the teeth of the electric motor sprocket 6 in a radial direction of the electric motor sprocket 6. In other words, the engaging pin 821 partially protrudes outward from a space between the pair of adjacent teeth. When described in detail, half or more of the engaging pin 821 protrudes outward from the space between the pair of adjacent teeth. The engaging pin 821 is in contact with the teeth of the electric motor sprocket 6 at a position outside a pitch circle P of the electric motor sprocket 6 in the radial direction of the electric motor sprocket 6.

As shown in FIG. 3, the engaging pin 821 is engaged with the teeth of the electric motor sprocket 6 on an imaginary line L. Here, the imaginary line L refers to a line connecting the rotational axis of the electric motor sprocket 6 and that of the drive wheel sprocket 4.

According to the drive unit 100 configured as described above, when the pallet truck 200 is stopped, the drive wheel 3 can be made non-rotatable by setting the brake mechanism 8 in the braking state, in other words, by operating the operating portion 822 of the brake body 82 such that the engaging pin 821 engages with the electric motor sprocket 6. As a result, the pallet truck 200 the stopped state can be maintained.

### <Battery and Mount Plate>

As shown in FIGS. 2 and 3, the battery 11 is attached to the frame 2 through the mount plate 12. The battery 11 supplies electric power to the electric motor 5 and so forth. The mount plate 12 protrudes both forward of and in the width direction from the battery 11 so as to prevent the battery 11 from colliding with an obstacle or so forth. The outer peripheral part of the mount plate 12 is made of an elastic body including metallic core rods in the interior thereof.

### <Vehicle Wheel Covers>

Each of the pair of vehicle wheel covers 13 is provided to prevent the foot of the user or so forth from touching a corresponding one of the vehicle wheels 204 of the pallet truck 200. Each vehicle wheel cover 13 is disposed ahead of the corresponding vehicle wheel 204. Each vehicle wheel cover 13 is attached to the frame 2.

When described in detail, each vehicle wheel cover 13 is fastened to the frame 2 by a bolt 102. Besides, each vehicle wheel cover 13 includes a cutout portion 131. Each vehicle wheel cover 13 is hooked on a protruding portion 103 protruding from the frame 2 through the cutout portion 131. Accordingly, rotation of each vehicle wheel cover 13 can be prevented. It should be noted that the protruding portion 103 and the cutout portion 131 of each vehicle wheel cover 13 overlap with the vehicle wheels 204 in a side view.

### Modifications

One preferred embodiment of the present invention has been explained above. However, the present invention is not limited to the above, and a variety of changes can be made without departing from the gist of the present invention. It should be noted that basically speaking, respective modifications to be described are applicable simultaneously.

(a) The rotary member, provided as an object to be braked by the brake mechanism 8, can be something other than the electric motor sprocket 6. For example, the brake mechanism 8 may brake the drive wheel sprocket 4. Other than this configuration, the brake mechanism 9 may brake another sprocket installed between the electric motor sprocket 6 and the drive wheel sprocket 4. Alternatively, the rotary member, provided as an object to be braked by the brake mechanism 8, can be in the form of something other than a sprocket.

(b) In the preferred embodiment described above, the engaging pin 821, configured to be protruded and retracted, is provided as the engaging portion of the brake mechanism; however, the engaging portion of the brake mechanism is not limited to this. For example, the engaging portion of the brake mechanism may be plate shaped along the teeth of the electric motor sprocket 6. In this case, the plate is configured to be engaged with or disengaged from the teeth of the electric motor sprocket 6 when moved closer to or away from the electric motor sprocket 6 in the back-and-forth direction.

(c) A reducer may be installed between the electric motor 5 and the drive wheel 3. In this case, the reducer is disposed between the electric motor sprocket 6 and the drive wheel sprocket 4. The reducer reduces the speed of the mechanical power generated by the electric motor 5 and transmits the mechanical power reduced in speed to the drive wheel 3.

(d) The engaging pin 821 may be engaged with the teeth of the electric motor sprocket 6 at a position located above the imaginary line L.

### LIST OF REFERENCE NUMERALS

2: Frame, 3: Drive wheel, 31: Rotational shaft, 4: Drive wheel sprocket, 5: Electric motor, 51: Output shaft, 6: Electric motor sprocket, 7: Chain, 8: Brake mechanism, 81: Attachment plate, 82: Brake body, 821: Engaging pin, 100: Drive unit

1. A drive unit comprising:
a frame;
a drive wheel rotatably supported by the frame;
an electric motor supported by the frame, the electric motor configured to drive the drive wheel;
a rotary member configured to be rotated in conjunction with the drive wheel; and
a brake mechanism including an engaging portion, the brake mechanism switchable between a braking state and an unbraking state, when the brake mechanism is set in the braking state the engaging portion is engaged with the rotary member so as to brake rotation of the rotary member, when the brake mechanism is set in the unbraking state the engaging portion is disengaged from the rotary member allowing the rotary member to rotate.

2. The drive unit according to claim 1, wherein the engaging portion is movable along an axial direction of the rotary member.

3. The drive unit according to claim 1, wherein
the rotary member is a sprocket, and
the engaging portion is engaged with teeth of the sprocket when the brake mechanism is set in the braking state.

4. The drive unit according to claim 3, wherein the engaging portion is partially disposed outside tips of the teeth of the sprocket in a radial direction of the sprocket.

5. The drive unit according to claim 3, wherein the engaging portion is in contact with the teeth of the sprocket at a position outside a pitch circle of the sprocket in a radial direction of the sprocket.

6. The drive unit according to claim 1, further comprising:
a transmission member configured to transmit mechanical power between the electric motor and the drive wheel, wherein
the rotary member is attached to an output shaft of the electric motor, and
the electric motor and the engaging portion are movable in an extending direction of the transmission member.

7. The drive unit according to claim 1, wherein
the brake mechanism includes an attachment plate and a brake body, the attachment plate attached to the frame, the brake body attached to the attachment plate, and
the brake body includes the engaging portion on a distal end thereof.

8. The drive unit according to claim 7, wherein
the electric motor is attached to the frame so as to be pivotable about a pivot axis, and
the attachment plate is attached to the frame so as to be pivotable about the pivot axis.

9. The drive unit according to claim 1, further comprising:
a drive wheel sprocket attached to a rotational shaft of the drive wheel, wherein
the rotary member is an electric motor sprocket attached to an output shaft of the electric motor.

10. The drive unit according to claim 9, wherein the engaging portion is engaged with teeth of the electric motor sprocket at a position on or above an imaginary line connecting a rotational axis of the electric motor sprocket and a rotational axis of the drive wheel sprocket.

11. The drive unit according to claim 7, wherein the brake mechanism further includes an operating portion that controls protruding and retracting of the engaging portion.

12. The drive unit according to claim 11, wherein rotation of the operating portion causes the engaging portion to protrude and to retract.

13. The drive unit according to claim 4, wherein the engaging portion is in contact with the teeth of the sprocket at a position outside a pitch circle of the sprocket in a radial direction of the sprocket.

14. The drive unit according to claim 2, further comprising:
a transmission member configured to transmit mechanical power between the electric motor and the drive wheel, wherein
the rotary member is attached to an output shaft of the electric motor, and
the electric motor and the engaging portion are movable in an extending direction of the transmission member.

15. The drive unit according to claim 3, further comprising:
a transmission member configured to transmit mechanical power between the electric motor and the drive wheel, wherein
the rotary member is attached to an output shaft of the electric motor, and
the electric motor and the engaging portion are movable in an extending direction of the transmission member.

16. The drive unit according to claim 4, further comprising:
a transmission member configured to transmit mechanical power between the electric motor and the drive wheel, wherein
the rotary member is attached to an output shaft of the electric motor, and
the electric motor and the engaging portion are movable in an extending direction of the transmission member.

17. The drive unit according to claim 2, wherein
the brake mechanism includes an attachment plate and a brake body, the attachment plate attached to the frame, the brake body attached to the attachment plate, and
the brake body includes the engaging portion on a distal end thereof.

18. The drive unit according to claim 3, wherein
the brake mechanism includes an attachment plate and a brake body, the attachment plate attached to the frame, the brake body attached to the attachment plate, and
the brake body includes the engaging portion on a distal end thereof.

19. The drive unit according to claim 4, wherein
the brake mechanism includes an attachment plate and a brake body, the attachment plate attached to the frame, the brake body attached to the attachment plate, and
the brake body includes the engaging portion on a distal end thereof.

20. The drive unit according to claim 5, wherein
the brake mechanism includes an attachment plate and a brake body, the attachment plate attached to the frame, the brake body attached to the attachment plate, and
the brake body includes the engaging portion on a distal end thereof.
